(19) United States
(12) Patent Application Publication
(10) Pub. No.: US 2009/0032371 A1
(43) Pub. Date: Feb. 5, 2009

(54) Wiper for a conveyor belt

(76) Inventor: Peter Hoessl, Altenberg (AT)

Correspondence Address: COLLARD & ROE, P.C., 1077 NORTHERN BOULEVARD, ROSLYN, NY, 11576, US

(21) Appl. No.: 12/220,806

(22) Filed: Jul. 29, 2008

(30) Foreign Application Priority Data
Aug. 3, 2007 (AT) A 1221/2007

(51) Int. Cl. B65G 45/12

(52) U.S. Cl. 198/497

(57) ABSTRACT

A wiper for a conveyor belt (8) is described having a rubber-elastic wiper strip (4) replaceably inserted into a retainer (3) and possibly assembled from individual strip sections arrayed adjacent to one another, which forms a wiper edge (6) between a rear (9) facing away from the conveyor belt (8) and a flank (10) facing toward the conveyor belt (8) and running out into a free surface (11), and which tapers toward the front ends starting from a central longitudinal section. To lengthen the service life of the wiper strip, it is suggested that the wiper strip (4) be tapered by a flank setback (12) in a wear area adjoining the free surface (11).

### FIELD OF THE INVENTION

The invention relates to a wiper for a conveyor belt having a rubber-elastic wiper strip, replaceably inserted into a retainer and possibly assembled from individual strip sections arrayed adjacent to one another, which forms a wiper edge between a rear facing away from the conveyor belt and a flank facing toward the conveyor belt and running out into a free surface, and which tapers from a central longitudinal section toward the front ends.

### DESCRIPTION OF THE PRIOR ART

Using wipers which comprise a retainer and a rubber-elastic wiper strip inserted into the retainer, which forms a wiper edge and using which the wiper edge is pressed against the conveyor belt under an elastic pre-tension, is known for wiping off residual product adhering to a conveyor belt (WO 93/13000 A1). Because the conveyed product accumulates in a central width area of the conveyor belt, the wear strain of the wiper strip is greater in a central longitudinal section than in the edge sections, which has the result that the wiper edge assumes an increasingly concave curve in a central longitudinal area as a result of wear with increasing service life, with the result that the contact of the wiper edge on the conveyor belt may no longer be ensured in the area of its concave curve, so that the wiping action is significantly worsened.

To lengthen the service life of the wiper strip, a wiper has already been suggested (WO 03/035518 A1), in which the wiper strip is constructed in the wear area from two layers, of which the layer forming the rear of the wiper strip and facing away from the conveyor belt has a lower hardness but a greater wear resistance than the other layer, which forms the flank of the wiper strip facing toward the conveyor belt. A formation of a thin lip in the area of the wiper edge caused by the wear in the flank area is to be avoided by this measure, in order to ensure sufficient contact pressure of the wiper edge on the conveyor belt even over a longer service life via the pre-tension. Notwithstanding the fact that wiper strips made of two materials which differ in regard to the wear resistance and the hardness are complex, the differing wear strain of the wiper strip in the area of the wiper edge due to the unequal product distribution over the width of the conveyor belt may not be compensated for by such a measure.

Finally, counteracting the uneven wear of the wiper strip over its length by providing it with tapering end sections, in that the backs of these end sections are correspondingly set back, is known (JP 2005-059996 A1). Due to the lesser thickness of the end sections, greater deformability of the wiper strip results in this area, with the desired effect that a uniform contact of the wiper edge on the conveyor belt may thus be ensured, even if greater wear results in the central section. However, because the wiper strip is pressed against the conveyor belt over its length at a uniform torque, hollowing of the wiper edge in the central section caused by wear results in relief of the end sections if the wiper strip is pressed flush against the conveyor belt in this central wear area, which endangers the wiping action in the area of the end sections.

### SUMMARY OF THE INVENTION

The invention is thus based on the object of designing a wiper of the type described at the beginning in such a way that in spite of the uneven wear strain over the length of the wiper edge, the service life of the wiper may be increased, without having to accept consequential losses in regard to the wiping action.

The invention achieves the stated object in that the wiper strip is tapered by a flank setback on the wear area adjoining the free surface.

Because of the tapering of the wiper strip towards its ends resulting due to a flank setback in the strip longitudinal direction, the differing wear strain of the wiper strip may advantageously be compensated for and, in contrast to the prior art, a concave curve of the wiper edge caused thereby may be avoided, because with progressing wear, the wiper edge is increasingly displaced into the terminal flank setback, which takes into consideration the lesser wear in the end areas of the wiper strip. Because of the flank setback provided adjoining the free surface, the lesser wear of the end sections in relation to the central section does not cause a concave curve of the wiper edge. The wiper edge is increasingly displaced into the area of the terminal flank setbacks with increasing wear in the central longitudinal section, so that in spite of the uneven wear abrasion an essentially linear continuous wiper edge may be ensured over the service life of the wiper strip. The curve of the flank setback only has to be adapted to the average distribution of the wear strain over the length of the wiper edge for this purpose.

If the wiper strip is assembled from individual strip sections arrayed adjacent to one another, especially simple design conditions result if the terminal strip sections of the wiper strip have a continuous flank setback over the entire section length, so that wiper strips may be joined from the individual strip sections in stepped lengths having end sections which ensure a linearly running wiper edge because of the thickness reduction in spite of the wear abrasion which decreases toward the ends.

For reasons of saving weight and material, the wiper strips are typically implemented as hollow chamber profiles. Dirty water may collect in these hollow chamber profiles, from which solids may accumulate in the hollow chambers, which has a disadvantageous effect on the elastic bending behavior of the wiper strip in certain circumstances. To avoid such deposits, the wiper may comprise a hollow profile whose peripherally-closed hollow chamber has a floor sinking toward the particular strip end in the area of the flank setback, so that dirty water accumulating in the area of the hollow profile may drain outward due to gravity.

### BRIEF DESCRIPTION OF THE DRAWING

The object of the invention is illustrated in an exemplary embodiment in the drawing. In the figures:

FIG. 1 shows a wiper according to the invention for a conveyor belt in a frontal view,

FIG. 2 shows this wiper in detail in a partially cutaway view of the flank of the wiper strip facing toward the conveyor belt in a smaller scale, and

FIG. 3 shows a section along line III-III of FIG. 1, also in a smaller scale.

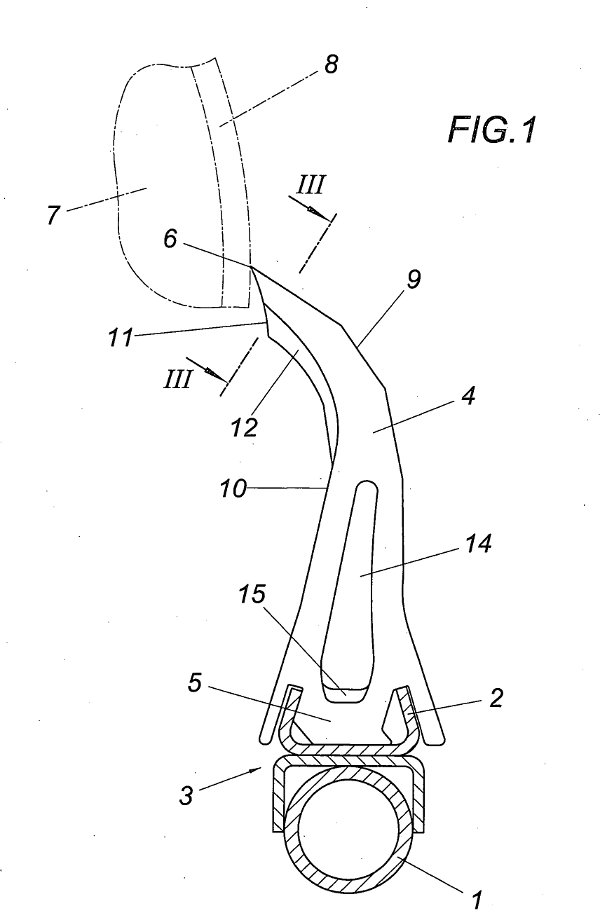

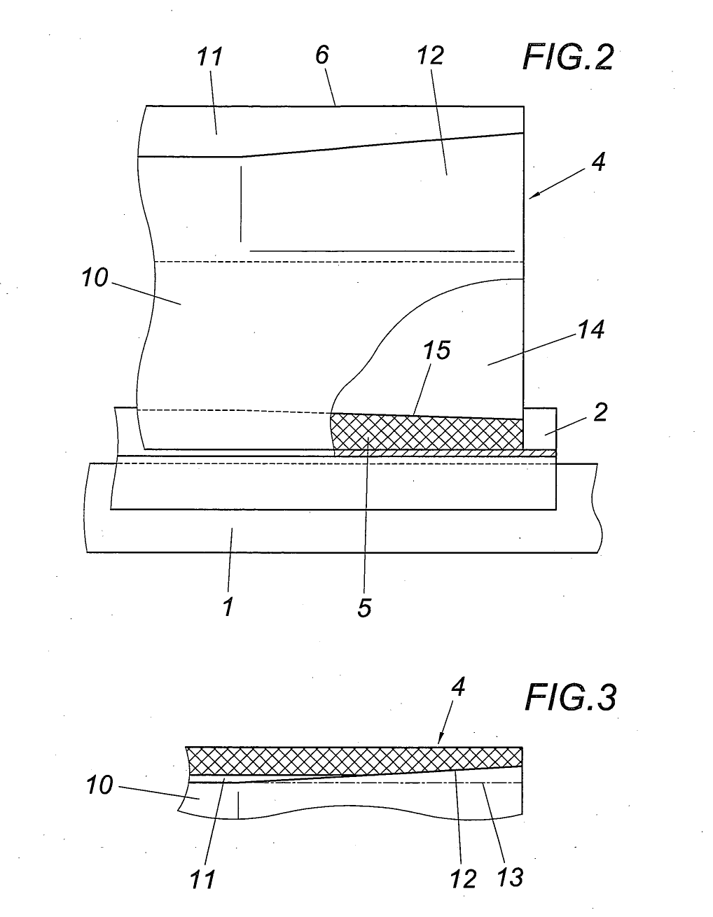

### DESCRIPTION OF THE PREFERRED EMBODIMENT

The illustrated wiper has a retainer 3, composed of a support 1 and a retainer rail 2, for a wiper strip 4, which is inserted using a base part 5 in the retainer rail 2 of the retainer 3. The wiper strip 4, which is formed from a rubber-elastic hollow profile, has a wiper edge 6 pressing against a conveyor belt 8 guided around a deflection roll 7 under an elastic pretension. The wiper edge 6 is formed between the rear 9 facing away from the conveyor belt 8 and a flank 10 facing toward the conveyor belt 8, which runs out toward the wiper edge 6 into a free surface 11.

The flanks 10 of the wiper strip 4 are set back starting from a central area toward the ends of the wiper strip 4, so that a tapering of the wiper strip 4 results in a longitudinal section adjoining the free surface 11, as may be inferred from FIG. 3 in particular, in which the flank setback 12 is obvious in comparison to the imaginary extension, indicated by a-dot-dash line, of the flank curve 13, which is linear over the central strip section. Because of the thickness decrease of the wiper strip 4 towards its ends, resulting due to the flank setback 12, the greater wear strain of the wiper strip 4 in a central longitudinal section may be taken into consideration, so that due to the interaction of the lesser wear strain and the thickness decrease of the wiper strip 4 toward the front ends, an essentially linear continuous wiper edge 6 over the entire service life of the wiper strip 4 may result, because the wiper strip 4 has a uniform thickness over its length after a corresponding wear abrasion in the area of the wiper edge 6.

To prevent dirty water from collecting in the hollow chamber 14 of the wiper strip 4, the wiper strip 4 may sink toward the front ends in the area of the flank setback 12 of the floor 15 of the hollow chamber 14, because of which the draining of dirty water from the hollow chamber as a result of gravity is ensured and sediment formation is thus avoided.

According to the exemplary embodiment shown, the wiper strip 4 is shown in one piece, which is not required in any way, however. Rather, the wiper strip 4 may also be composed of individual strip sections in a typical way, which are arrayed adjacent to one another to form the particular wiper strip. In such a case, it is recommended that the terminal strip sections be implemented having the flank setback 12 and/or the sinking floor 15 of the hollow chamber 14, both the flank setback 12 and also the sinking floor 15 extending over the entire length of the terminal strip section. It does not need to be noted that the terminal strip sections of a wiper strip 4 must be shaped differently to take the orientation of the flank setback 12 and/or the floor inclination toward the terminal ends of the wiper strip 4 into consideration.

1. A wiper for a conveyor belt having a rubber-elastic wiper strip replaceably inserted into a retainer and possibly assembled from individual strip sections arrayed adjacent to one another, which forms a wiper edge between a rear facing away from the conveyor belt and a flank facing toward the conveyor belt and running out into a free surface, and which tapers toward the front ends starting from a central longitudinal section, wherein the wiper strip (4) is tapered in a wear area adjoining the free surface (11) by a flank setback (12).

2. The wiper according to claim 1 having a wiper strip assembled from individual strip sections arrayed adjacent to one another, wherein the terminal strip sections of the wiper strip (4) have a continuous flank setback (12) over the entire section length.

3. The wiper according to claim 1, wherein the wiper comprises a hollow profile whose peripherally-closed hollow chamber (14) has a floor (15) which sinks toward the particular strip end in the area of the flank setback (12).
